(19) United States
(12) Patent Application Publication
(10) Pub. No.: US 2024/0118946 A1
(43) Pub. Date: Apr. 11, 2024

(54) API ADAPTER GENERATOR, API ADAPTER GENERATION METHOD, AND API ADAPTER GENERATION PROGRAM

(71) Applicant: Nippon Telegraph and Telephone Corporation, Tokyo (JP)

(72) Inventors: Naoki TAKE, Musashino-shi, Tokyo (JP); Yoshifumi KATO, Musashino-shi, Tokyo (JP); Miwaka OTANI, Musashino-shi, Tokyo (JP); Kiyotaka SAITO, Musashino-shi, Tokyo (JP); Satoshi KONDO, Musashino-shi, Tokyo (JP); Yu MIYOSHI, Musashino-shi, Tokyo (JP)

(21) Appl. No.: 18/554,256

(22) PCT Filed: Apr. 7, 2021
(86) PCT No.: PCT/JP2021/014763

§ 371 Date: Oct. 6, 2023

(51) Int. Cl. G06F 9/54

(52) U.S. Cl. CPC G06F 9/541

(57) ABSTRACT

An API adapter generation device include a conversion rule calculation unit (16) configured to acquire a data model of an orchestrator (210) and an API specification to be managed and perform schema matching on the basis of a data schema of the orchestrator and a data schema of the API specification to calculate a model conversion rule, a call logic unit generation unit (19) configured to rewrite a source code of an API call logic unit 232 describing an API adapter execution logic on the basis of the model conversion rule, and an API adapter generation unit (21) configured to generate an API adapter to be managed on the basis of the API call logic unit in which the source code is rewritten.

### TECHNICAL FIELD

The present invention relates to an API adapter generation device, an API adapter generation method, and an API adapter generation program.

### BACKGROUND ART

An orchestrator that coordinates a plurality of services is used to construct and operate a service by combining a plurality of wholesale partner services. In the orchestrator, in a case where a new wholesale service (service to be managed) is added and in a case where a specification of an existing service is changed, it is required to add and change an API adapter at low cost and in a short period of time.

Non Patent Literature 1 discloses a technique for automatically generating an API adapter that absorbs a difference in a specification of an API for each of various services to be used. In addition, Non Patent Literature 2 discloses automating part of a test for a control signal and a data signal between an API adapter and a wholesale service.

### CITATION LIST

### Non Patent Literature

Non Patent Literature 1: Take et al., “Discussion on Web API Adapter Development Facilitation” 2017.9, The Institute of Electronics, Information and Communication Engineers NWS Study Group
Non Patent Literature 2: Sho Kanemaru, Tomoki ikegava, Kensuke Takahashi, Tsuyoshi Toyoshima, “Proposal of comprehensive test automation method for API adapter in C-Plane and U-Plane”, IEICE Technical Report

### SUMMARY OF INVENTION

### Technical Problem

However, a process of generating an API adapter includes a design process, an implementation process, and a test process, and in the technique disclosed in Non Patent Literature 1 described above, automation of the design process is not described, and the design process needs to be manually performed by a user. For this reason, there is a problem that it is difficult to reduce cost and shorten a period for adding an API adapter and changing a specification.

The present invention has been made in view of the above circumstances, and an object thereof is to provide an API adapter generation device, an API adapter generation method, and an API adapter generation program capable of adding an API adapter and changing a specification at low cost in a short period of time.

### Solution to Problem

An API adapter generation device according to an aspect of the present invention includes: a conversion rule calculation unit configured to acquire a data model of an orchestrator and an API specification to be managed and perform schema matching on the basis of a data schema of the orchestrator and a data schema of the API specification to calculate a model conversion rule; a generation unit configured to rewrite a source code of an API call logic unit describing an API adapter execution logic on the basis of the model conversion rule; and an API adapter generation unit configured to generate an API adapter to be managed on the basis of the API call logic unit in which the source code is rewritten.

An API adapter generation method according to an aspect of the present invention is an API adapter generation method to be performed by a computer, the API adapter generation method including: a step of acquiring a data model of an orchestrator and an API specification to be managed; a step of performing schema matching on the basis of a data schema of the orchestrator and a data schema of the API specification to calculate a model conversion rule; a step of rewriting a source code of an API call logic unit describing an API adapter execution logic on the basis of the model conversion rule; and a step of generating an API adapter to be managed on the basis of the API call logic unit in which the source code is rewritten.

An aspect of the present invention is an API adapter generation program for causing a computer to function as the API adapter generation device.

### Advantageous Effects of Invention

According to the present invention, it is possible to add an API adapter and change use at low cost in a short period of time.

### BRIEF DESCRIPTION OF DRAWINGS

FIG. 1 is a block diagram illustrating a configuration of a network system in which an API adapter generation device according to an embodiment is to be employed.

FIG. 2 is a block diagram illustrating a configuration of an API adapter generation device and an API adapter according to an embodiment.

FIG. 3 is a block diagram illustrating a configuration of an API adapter generation device according to a first embodiment.

FIG. 4 is an explanatory diagram illustrating an example where an API specification described in an open API specification format is converted into a data model in a UML format.

FIG. 5A is an explanatory diagram illustrating resource design and parameter design of data models M1 and M2 of respective companies when API adapters of services to be managed by the companies A and B are generated.

FIG. 5B is an explanatory diagram illustrating conversion of parameter values of the data models M1 and M2 of respective companies when the API adapters of the services to be managed by the companies A and B are generated.

FIG. 5C is an explanatory diagram illustrating a relationship between an orchestrator AP and an orchestrator.

FIG. 6A is an explanatory diagram illustrating execution order of APIs in a case where a plurality of APIs is collectively managed.

FIG. 6B is an explanatory diagram illustrating logic design of each data model when services to be managed by a company C, a company D, and a company E are added.

FIG. 7A is an explanatory diagram illustrating a correspondence relationship when resources and parameters of the data model M1 are converted into resources and parameters of the data model M3 of an orchestrator.

FIG. 7B is an explanatory diagram illustrating a source code describing resources and parameters illustrated in FIG. 7A.

FIG. 8A is an explanatory diagram illustrating a correspondence relationship when parameter values of the data model M1 are converted into parameter values of the data model M3 of the orchestrator.

FIG. 8B is an explanatory diagram illustrating a source code describing the parameter values illustrated in FIG. 8A.

FIG. 9 is a flowchart illustrating processing procedure of the API adapter generation device according to the first embodiment.

FIG. 10 is a block diagram illustrating a configuration of an API adapter generation device according to a second embodiment.

FIG. 11 is an explanatory diagram illustrating a correspondence relationship when resources and parameters of data models M11 to M13 are converted into resources and parameters of a data model M14 of an orchestrator.

FIG. 12 is an explanatory diagram illustrating procedure for generating a source code of a data model according to a conversion rule according to the second embodiment.

FIG. 13 is an explanatory diagram illustrating a source code describing resources and parameters illustrated in FIG. 11.

FIG. 14 is a block diagram illustrating a configuration of an API adapter generation device according to a third embodiment.

FIG. 15A is an explanatory diagram illustrating a relationship between an orchestrator AP and an orchestrator according to the third embodiment.

FIG. 15B is an explanatory diagram illustrating a source code describing resources and parameters illustrated in FIG. 15A.

FIG. 15C is an explanatory diagram illustrating instance information of the source code illustrated in FIG. 15B.

FIG. 15D is an explanatory diagram illustrating configuration information of the source code illustrated in FIG. 15B.

FIG. 16A is an explanatory diagram illustrating data models of a plurality of orchestrator APs 203a, 203b, and 203c.

FIG. 16B is an explanatory diagram illustrating a configuration information graph of a basic data model of the orchestrator AP.

FIG. 16C is a view for explaining generation of a computing resource 50 on the basis of similarity of parameters 51, 52, and 53.

FIG. 17 is a block diagram illustrating a hardware configuration of the present embodiment.

### DESCRIPTION OF EMBODIMENTS

[Configuration of Network System]

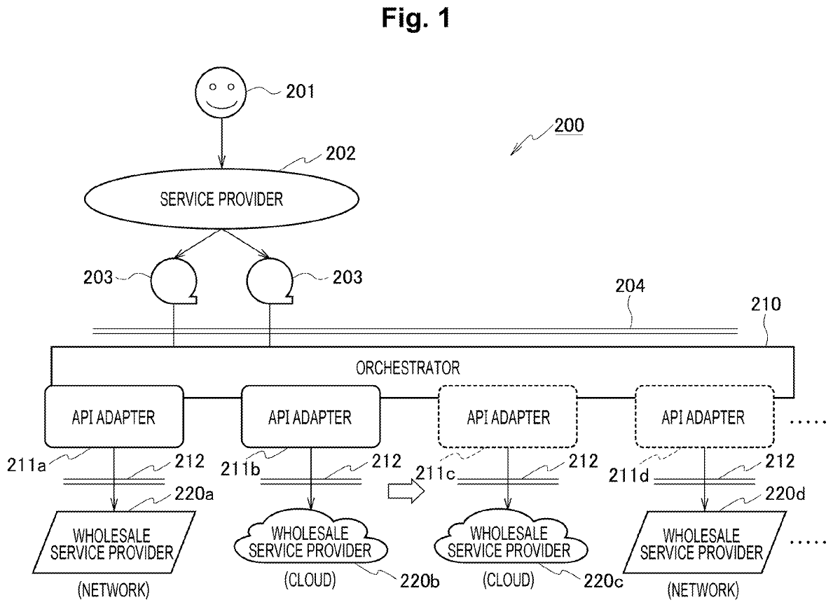

Hereinafter, embodiments of the present invention will be described. FIG. 1 is a block diagram illustrating a configuration of a network system 200 in which an API adapter generation device according to an embodiment is to be employed. First, the network system 200 will be described with reference to FIG. 1.

In the network system 200 illustrated in FIG. 1, if a desired service is requested, an end user 201 connected to a service provider 202 can receive services to be managed provided from a plurality of wholesale service providers 220 (220a to 220d) set on a network or a cloud.

In the present embodiment, an example in which two wholesale service providers 220a and 220b already exist in the network system 200, and two wholesale service providers 220c and 220d are newly added will be described. The wholesale service providers 220a and 220d provide services to be managed by the network. The wholesale service providers 220b and 220c provide services to be managed by the cloud.

Hereinafter, in a case where the wholesale service provider is specified and indicated, it is indicated by attaching a suffix, such as “wholesale service provider 220a”, and in a case where the wholesale service provider is not specified and is collectively indicated, it is indicated without a suffix, such as “wholesale service provider 220”. The same applies to other reference numerals.

An orchestrator 210 and API adapters 211 (211a to 211d) corresponding to the respective wholesale service providers 220 are provided between the service provider 202 and the respective wholesale service providers 220.

The orchestrator 210 acquires an orchestrator AP 203 provided from the service provider 202 and collectively coordinates services combining a network, a cloud and an application, of the respective wholesale service providers 220.

In other words, specifications of services to be managed provided by the respective wholesale service providers 220 are different for each wholesale service provider 220. Thus, in a case where the service provider 202 combines a plurality of services to be managed to provide a new service, it is necessary to absorb a difference in the specification and to coordinate the plurality of services to be managed. The orchestrator 210 performs this coordination.

The orchestrator AP 203 is an application generated using a northbound API 204 which will be described below. The orchestrator AP 203 includes a build-out configuration AP and an autonomous operation AP. The orchestrator AP 203 is, for example, a catalog. The catalog is a data file describing a specification of each service to be managed necessary for coordinating a plurality of services to be managed.

The northbound API 204 is provided between the service provider 202 and the orchestrator 210. The northbound API 204 is an interface that connects the service provider 202 and the orchestrator 210.

A southbound API 212 is provided between each wholesale service provider 220 and the orchestrator 210. The southbound API 212 is an interface that connects each wholesale service provider 220 and the orchestrator 210.

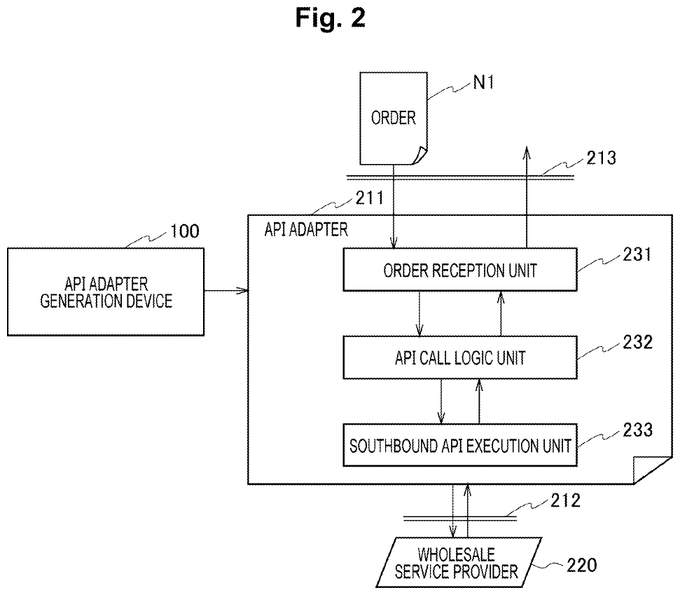

The orchestrator 210 is connected to an API adapter 211 installed corresponding to each wholesale service provider 220 via an internal API 213 (see FIG. 2). The API adapter 211 is generated for each wholesale service provider 220 and absorbs a difference in a specification of the API provided by each wholesale service provider 220.

The orchestrator 210 decomposes an order issued by the service provider 202 into a “single order” which is a unit that can be processed by the API adapter 211 for each wholesale service provider 220 and transmits the decomposed order to the API adapter 211 (211a to 211d) of each wholesale service provider 220 (220a to 220d).

Each API adapter 211 has a function of mutually converting a data model of the orchestrator 210 and a data model of each wholesale service provider 220.

As described above, in the network system 200 in which the two wholesale service providers 220a and 220b are already installed, in a case where services to be managed provided by the two wholesale service providers 220c and 220d are added, it is necessary to generate the API adapters 211c and 211d. In other words, as illustrated in FIG. 1, it is necessary to newly generate the API adapters 211c and 211d in addition to the existing API adapters 211a and 211b.

In the present embodiment, at least part of generation of the API adapters 211c and 211d is automated so as to achieve reduce labor of a worker and cost. This will be described below in more detail.

FIG. 2 is a block diagram illustrating a detailed configuration of the API adapter 211 illustrated in FIG. 1. As illustrated in FIG. 2, the API adapter 211 includes an order reception unit 231, an API call logic unit 232, and a southbound API execution unit 233. The API adapter 211 is connected to the API adapter generation device 100 according to the present embodiment.

The order reception unit 231 receives an order N1 transmitted to the orchestrator 210 and acquires content of the order N1. The order reception unit 231 performs response processing to the orchestrator 210. Specifically, the order reception unit 231 performs state management and notification from when the order N1 is received until when execution of the order N1 is completed and distribution of an execution result according to procedure determined in advance with the orchestrator 210 as coordination order reception/response processing.

The order reception unit 231 receives a request from the API call logic unit 232 as order content acquisition processing and acquires detailed order content (catalog, or the like).

The API call logic unit 232 checks an activation condition of the southbound API 212 and activates the southbound API 212 according to preset execution order.

The API call logic unit 232 extracts parameters necessary for execution of the southbound API 212 from the order N1 from the orchestrator 210 and transmits the parameters to the southbound API execution unit 233. The API call logic unit 232 acquires an execution result of the southbound API 212 from the southbound API execution unit 233. The API call logic unit 232 converts the acquired execution result into an appropriate data format for distribution to the orchestrator 210.

The southbound API execution unit 233 acquires data necessary for executing the southbound API 212 from the API call logic unit 232, changes the data format and transmits the data to each wholesale service provider 220.

The southbound API execution unit 233 receives a response from each wholesale service provider 220, converts the response into an appropriate format and returns the converted response to the API call logic unit 232.

The southbound API execution unit 233 performs request transmission and response reception corresponding to each individual southbound API 212 with each wholesale service provider 220 through the southbound API 212 of each wholesale service provider 220.

As described above, in the network system 200 illustrated in FIG. 1, in a case where services to be managed by the wholesale service providers 220c and 220d are newly added, it is necessary to newly generate the API adapters 211c and 211d to be connected to the orchestrator 210.

In the present embodiment, at least part of the design of the API call logic unit 232 is automated by providing the API adapter generation device 100, and the API adapter 211 is generated.

It is necessary to perform design, implementation, and test when generating the API adapter 211. The design process includes “resource design”, “parameter design”, and “logic design”. The implementation process includes implementation of the API call logic unit 232. In the present embodiment, at least part of the “resource design”, the “parameter design”, and the “logic design” is automated. Further, implementation of the API call logic unit 232 is automated.

### First Embodiment

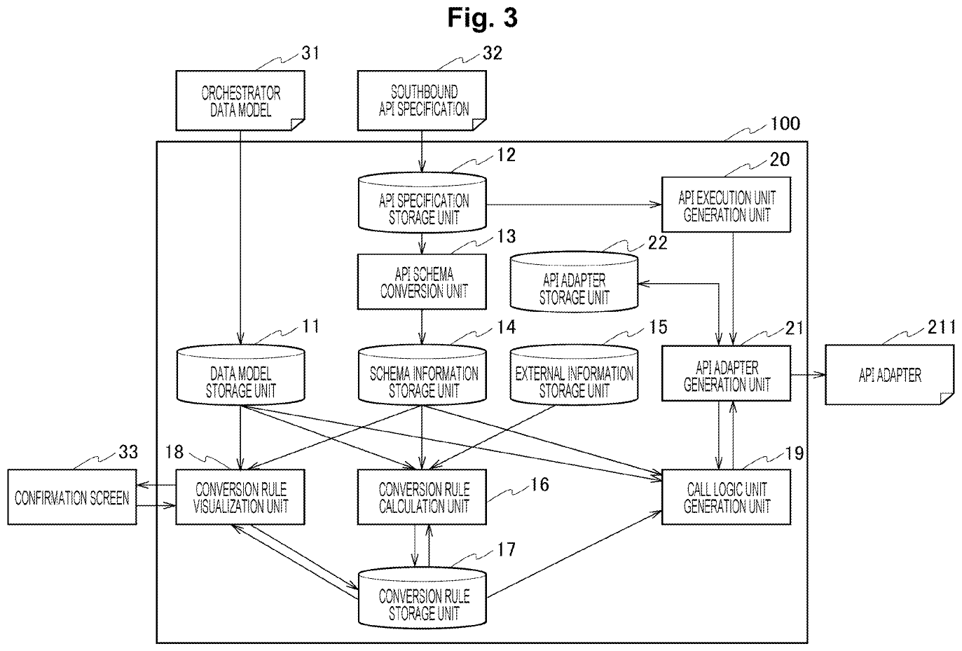

Next, a specific configuration of the API adapter generation device 100 according to the present embodiment will be described. FIG. 3 is a block diagram illustrating a detailed configuration of the API adapter generation device 100 and its peripheral equipment according to the first embodiment.

As illustrated in FIG. 3, the API adapter generation device 100 according to the present embodiment includes a data model storage unit 11, an API specification storage unit 12, an API schema conversion unit 13, a schema information storage unit 14, and an external information storage unit 15. The API adapter generation device 100 includes a conversion rule calculation unit 16, a conversion rule storage unit 17, a conversion rule visualization unit 18, a call logic unit generation unit 19 (generation unit), an API execution unit generation unit 20, an API adapter generation unit 21, and an API adapter storage unit 22. A confirmation screen 33 is connected to the API adapter generation device 100.

The data model storage unit 11 acquires and stores an orchestrator data model 31 input from the orchestrator 210.

The API specification storage unit 12 acquires and stores a southbound API specification 32 (API specification of a model to be managed) of a data model to be managed.

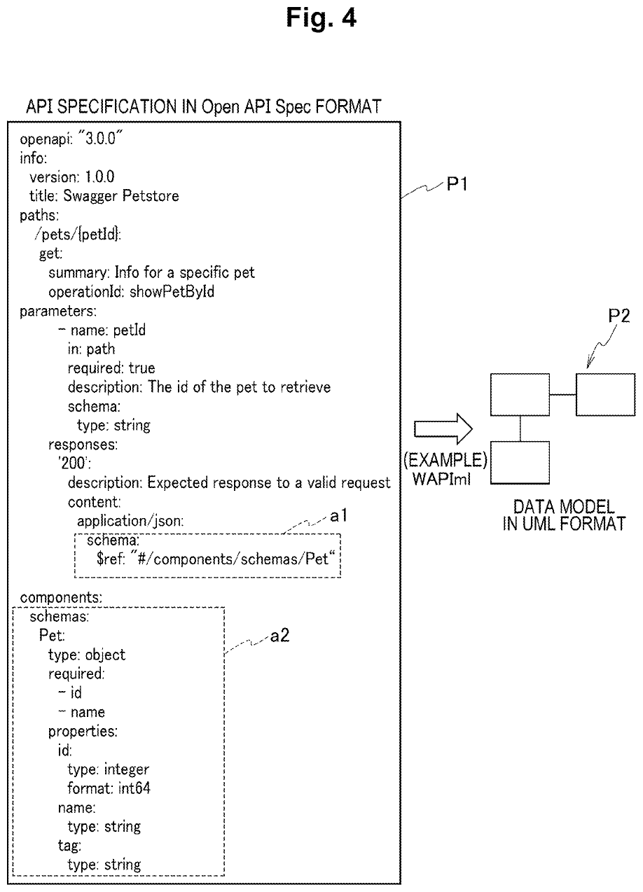

The API schema conversion unit 13 converts the southbound API specification 32 stored in the API specification storage unit 12 into a schema format. FIG. 4 is an explanatory diagram illustrating an example where an API specification P1 described in an open API specification format is converted into a data model P2 in a unified modeling language (UML) format. The schema information indicated by reference numerals a1 and a2 in FIG. 4 is converted into the data model P2 such as UML by, for example, “WAPIml”.

The schema information storage unit 14 stores the schema information converted by the API schema conversion unit 13.

The external information storage unit 15 stores information that is externally transmitted such as an ontology.

The conversion rule calculation unit 16 calculates a conversion rule of a data model using existing schema matching. The conversion rule calculation unit 16 performs resource design, parameter design, and logic design when the API adapter 211 is generated.

The conversion rule calculation unit 16 automates model conversion by applying a schema matching technique to a data schema that can be derived from the specification of the southbound API 212 and a portion that derives a conversion rule of the data schema in the orchestrator 210. Hereinafter, the “process of resource design and parameter design” and the “process of logic design” will be specifically described.

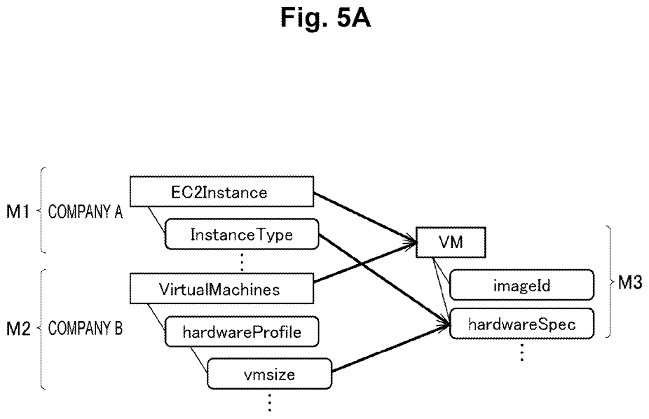

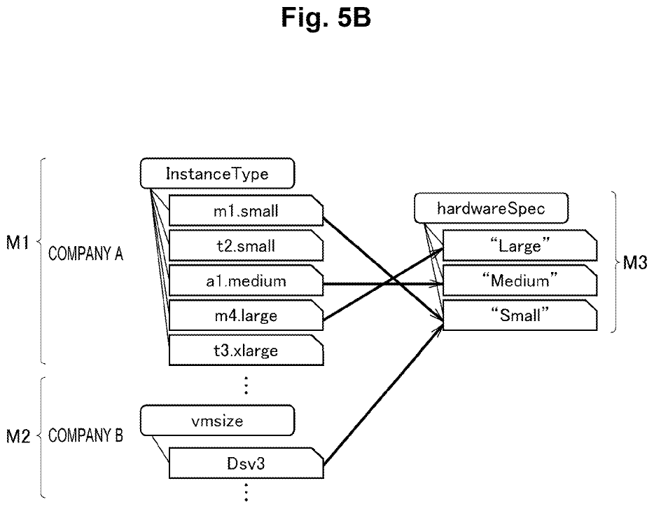

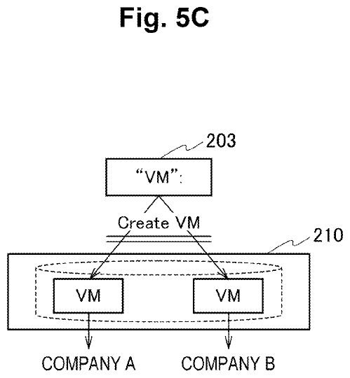

(Process of Resource Design and Parameter Design) Details of the resource design and the parameter design will be described with reference to FIGS. 5A, 5B, and 5C. FIG. 5A is an explanatory diagram illustrating resource design and parameter design of the data models M1 and M2 of respective companies when the API adapters of services to be managed by the companies A and B are generated. FIG. 5B is an explanatory diagram illustrating conversion of parameter values of the data models M1 and M2 of respective companies when the API adapters of the services to be managed by the companies A and B are generated. FIG. 5C is an explanatory diagram illustrating a relationship between the orchestrator AP and the orchestrator.

In order to implement the resource design and the parameter design, it is necessary to define conversion rules of the data models M1 and M2 of the services to be managed by the companies A and B and the data model M3 of the orchestrator 210. In addition, resources, a conversion rule in units of parameters, and a conversion rule of parameter values are required.

For example, as illustrated in FIG. 5A, by converting resources and parameters of the data model M1 of the company A and the data model of the company B, the data model M3 of the orchestrator 210 is generated. Specifically, “EC2Instance” of the data model M1 and “Virtual Machines” of the data model M2 are converted into “VM” of the data model M3. In addition, “Instance Type” of the data model M1 and “vmsize” of the data model M2 are converted into “hardware Spec” of the data model M3.

In addition, as illustrated in FIG. 5B, the parameter values of the data model M1 of the company A and the data model M2 of the company B are converted to generate the data model M3 of the orchestrator 210. Specifically, the data model M3 of the orchestrator 210 is simply set to three of “Large”, “Medium”, and “Small” that are independently defined. The parameter value “m1.small” of the data model M1 is converted into “Small”, “a1.medium” is converted into “Medium”, and “m4.Large” is converted into “Large”. The parameter value “Dsv3” of the data model M2 is converted into “Small”.

By setting the above conversion rule, as illustrated in FIG. 5C, the orchestrator 210 can use the data model without being conscious of a cloud vendor when a data model “VM” is given as the orchestrator AP 203. In other words, from the orchestrator AP 203, the data model M1 and the data model M2 illustrated in FIGS. 5A and 5B can be handled as similar data models “VM”.

Specifically, conversion of the data model illustrated in FIGS. 5A and 5B is performed using schema matching. As schema matching, for example, a “Graph-Based” method can be used. In the “Graph-Based” method, it is possible to match parameters in consideration of not only names of the parameters but also a graph/tree structure of the schema.

Further, it is also possible to use not only a schema of the data but also an “Instance-based” method that uses an actual data value (instance) and a “Hybrid” method that uses both the “Instance-based” method and schema information.

(Process of Logic Design)

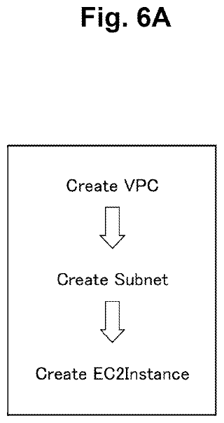

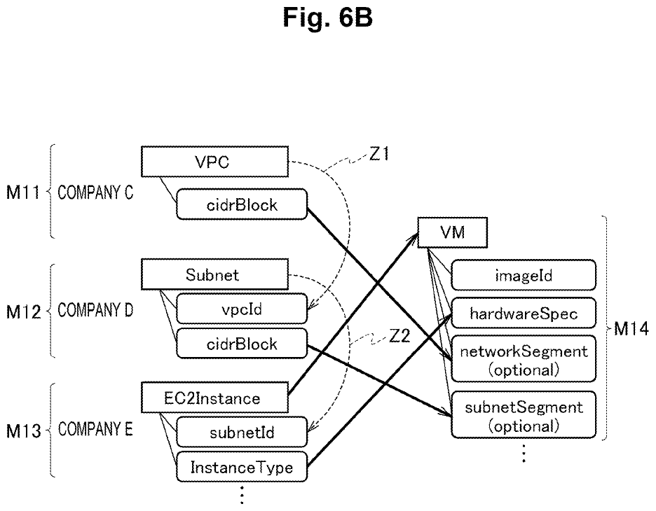

Next, details of the logic design will be described with reference to FIGS. 6A and 6B. FIG. 6A is an explanatory diagram illustrating execution order of the APIs. FIG. 6B is an explanatory diagram illustrating the logic design of each of the data models M11 to M13 when services to be managed by a company C which is a wholesale service provider 220 having the data model M12, a company D which is a wholesale service provider 220 having the data model M11, and a company E which is a wholesale service provider 220 having the data model M13 are added.

In a case where a plurality of resources in the services to be managed are collectively managed in one unit, it is necessary to define the execution order of the APIs and distribution relationships of the parameters. For example, as illustrated in FIG. 6A, the execution order of the APIs is defined in the order of “VPC”→“Subnet”→“EC2”.

In addition, as illustrated in FIG. 6B, in the data models M11 to M13 of the company C, the company D, and the company E, distribution relationships of the parameters are defined as arrows Z1 and Z2 in the drawing. As a result, the data model M14 of the orchestrator 210 in which a distribution relationship between the data models is defined is generated.

As described above, the conversion rule calculation unit 16 calculates the conversion rule of the data model and performs resource design, parameter design, and logic design when the API adapter 211 is generated. Furthermore, the call logic unit generation unit 19 which will be described later generates the API call logic unit 232 on the basis of results of the resource design, the parameter design, and the logic design.

Returning to FIG. 3, the conversion rule storage unit 17 stores the model conversion rule calculated by the conversion rule calculation unit 16.

The conversion rule visualization unit 18 outputs the model conversion rule stored in the conversion rule storage unit 17 on the confirmation screen 33 to visualize the model conversion rule so that the user can confirm the model conversion rule. For example, data of the model conversion rule is transmitted to the confirmation screen 33, and the data is displayed on the confirmation screen 33 to allow the user to recognize the model conversion rule.

The call logic unit generation unit 19 automatically generates the API call logic unit 232 on the basis of the results of the resource design, the parameter design, and the logic design calculated by the conversion rule calculation unit 16. The call logic unit generation unit 19 rewrites a source code of a template according to the model conversion rule calculated by the conversion rule calculation unit 16.

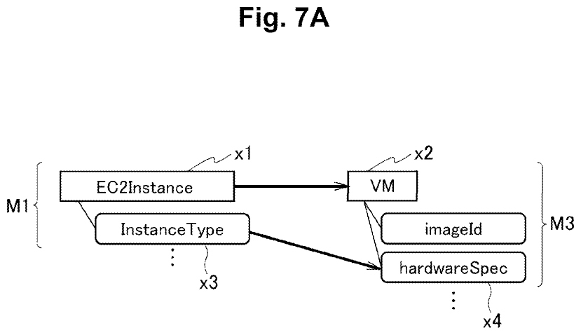

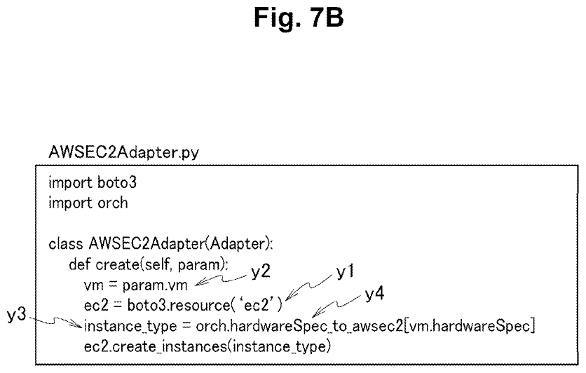

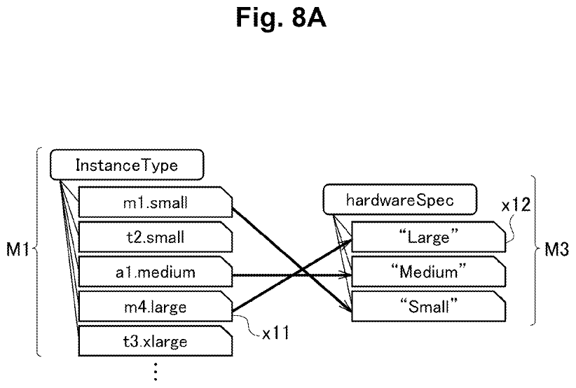

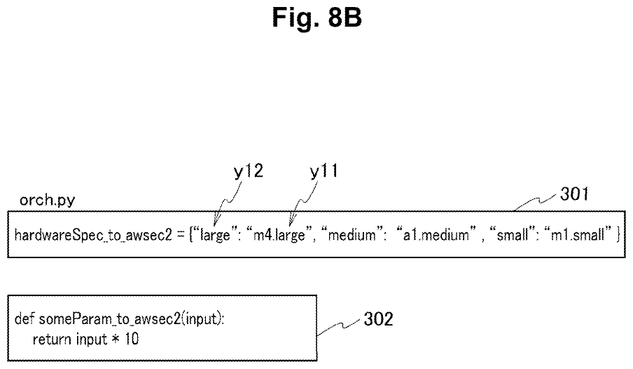

Hereinafter, source code generation procedure will be described with reference to FIGS. 7A, 7B, 8A, and 8B. FIG. 7A is an explanatory diagram illustrating a correspondence relationship when parameters of the data model M1 illustrated in FIG. 5A are converted into parameters of the data model M3 of the orchestrator 210, and FIG. 7B is an explanatory diagram illustrating a source code describing the parameters illustrated in FIG. 7A.

As illustrated in FIG. 7A, in a case where “EC2Instance” indicated by a reference numeral x1 of the data model M1 is changed to “VM” indicated by a reference numeral x2, and “InstanceType” indicated by a reference numeral x3 is changed to “hardwareSpec” indicated by a reference numeral x4, a source code is described as “ec2” indicated by a reference numeral y1, “instance type” indicated by a reference numeral y2, “vm” indicated by a reference numeral y3, and “hardwareSpec” indicated by a reference numeral y4 in FIG. 7B.

In other words, a template of the source code as illustrated in FIG. 7B is prepared in advance, and change data is written in the template, whereby the source code for converting between necessary data models can be generated.

FIG. 8A is an explanatory diagram illustrating a correspondence relationship when the parameter values of the data model M1 illustrated in FIG. 5B are converted into the parameter values of the data model M3 of the orchestrator 210. FIG. 8B is an explanatory diagram illustrating a source code describing the parameter values illustrated in FIG. 8A.

As illustrated in FIG. 8A, in a case where “M4.large” indicated by a reference numeral x11 of the data model M1 is changed to “Large” indicated by a reference numeral x12, “m4.large” indicated by a reference numeral y11 and “large” indicated by a reference numeral y12 of the source code 301 of FIG. 8B are described. Furthermore, in a case where some calculation logic is required, conversion into a function as illustrated in the source code 302 is performed.

Returning to FIG. 3, the API execution unit generation unit 20 generates the southbound API execution unit 233 (see FIG. 2) in the API adapter 211 on the basis of the southbound API specification 32 stored in the API specification storage unit 12. For the generation of the southbound API execution unit 233, for example, an existing tool such as “Swagger Codegen/Open API Generator” can be used.

The API adapter generation unit 21 generates the API adapter 211 on the basis of the call logic unit 232 and the southbound API execution unit 233 generated by the call logic unit generation unit 19. In addition, the stored API adapter 211 is output to the outside as necessary.

The API adapter storage unit 22 stores the API adapter 211 generated by the API adapter generation unit 21.

### Operation of First Embodiment

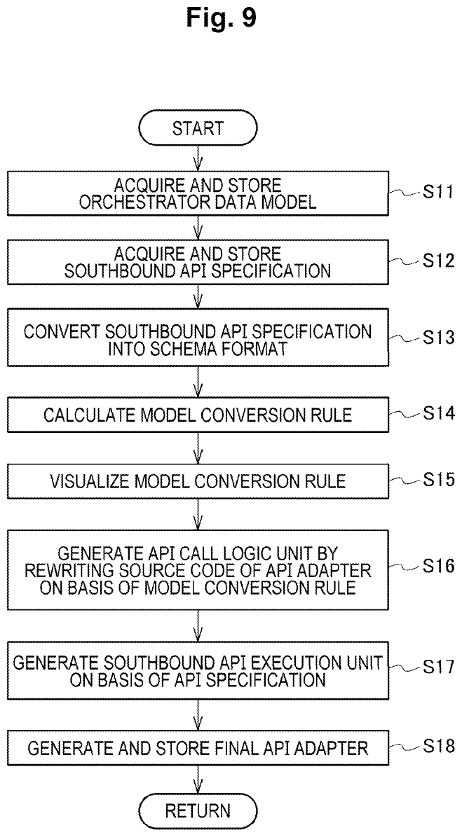

Next, processing procedure of the API adapter generation device 100 according to the first embodiment will be described with reference to a flowchart illustrated in FIG. 9. First, in step S11 of FIG. 9, the data model storage unit 11 acquires the orchestrator data model 31 output from the orchestrator 210 and stores the orchestrator data model in the data model storage unit 11.

In step S12, the API specification storage unit 12 acquires the southbound API specification 32 output from the orchestrator 210 and stores the specification in the API specification storage unit 12.

In step S13, the API schema conversion unit 13 converts the southbound API specification 32 stored in the API specification storage unit 12 into a schema format. The schema information after the conversion is stored in the schema information storage unit 14.

In step S14, the conversion rule calculation unit 16 calculates a model conversion rule on the basis of the orchestrator data model 31 stored in the data model storage unit 11, the schema information stored in the schema information storage unit 14, and external information stored in the external information storage unit 15. The conversion rule calculation unit 16 stores the calculated model conversion rule in the conversion rule storage unit 17.

In step S15, the conversion rule visualization unit 18 outputs the conversion rule stored in the conversion rule storage unit 17 to the confirmation screen 33 as necessary. The operator can recognize the conversion rule by viewing the confirmation screen 33.

In step S16, the call logic unit generation unit 19 rewrites the source code of the API adapter on the basis of the model conversion rule stored in the conversion rule storage unit 17 to generate the API call logic unit 232. As a result, the API call logic unit 232 can be automatically generated.

In step S17, the API execution unit generation unit 20 generates the southbound API execution unit 233 illustrated in FIG. 2 on the basis of the specification of the southbound API adapter stored in the API specification storage unit 12.

In step S18, the API adapter generation unit 21 generates the final API adapter 211 on the basis of the southbound API execution unit 233 generated by the API execution unit generation unit 20 and the API call logic unit 232 generated by the call logic unit generation unit 19. The generated API adapter 211 is stored in the API adapter storage unit 22.

### Effects of First Embodiment

As described above, the API adapter generation device 100 according to the first embodiment includes the conversion rule calculation unit 16 configured to acquire the data model of the orchestrator 210 and the API specification of the model to be managed and perform schema matching on the basis of the data schema of the orchestrator 210 and the data schema of the API specification to calculate the model conversion rule, the call logic unit generation unit 19 (generation unit) configured to rewrite the source code of the API call logic unit describing the API adapter execution logic on the basis of the model conversion rule, and the API adapter generation unit 21 configured to generate the API adapter of the model to be managed on the basis of the API call logic unit in which the source code is rewritten.

With the above configuration, when the wholesale service provider 220 having a new service to be managed is added to the orchestrator 210, the API adapter generation device 100 according to the first embodiment can easily perform a design process when the API adapter 211 is newly designed. Specifically, it is possible to reduce labor, time, and cost required for generating the API adapter 211.

In the first embodiment, the call logic unit generation unit 19 generates an API call logic unit by setting a template of a predetermined source code and generating a source code by writing at least one of resources, parameter names, or parameter values of an API specification to be managed in the template. This makes it possible to generate the API call logic unit 232 by simple operation.

### Second Embodiment

A second embodiment of the present invention will be described next. In the first embodiment described above, the API adapter 211 is generated using the template for the data model of the service to be managed newly connected to the network system 200. In the second embodiment, an example in which the API adapter 211 is generated by aggregating resources of a plurality of service models into one and performing matching by a many-to-one correspondence.

In the second embodiment, when matching is performed in a many-to-one correspondence, contribution rates of matching are made variable in resource units and parameter units. Alternatively, high-accuracy many-to-one matching is performed using a dependency relationship graph generated from the schema information of the southbound API.

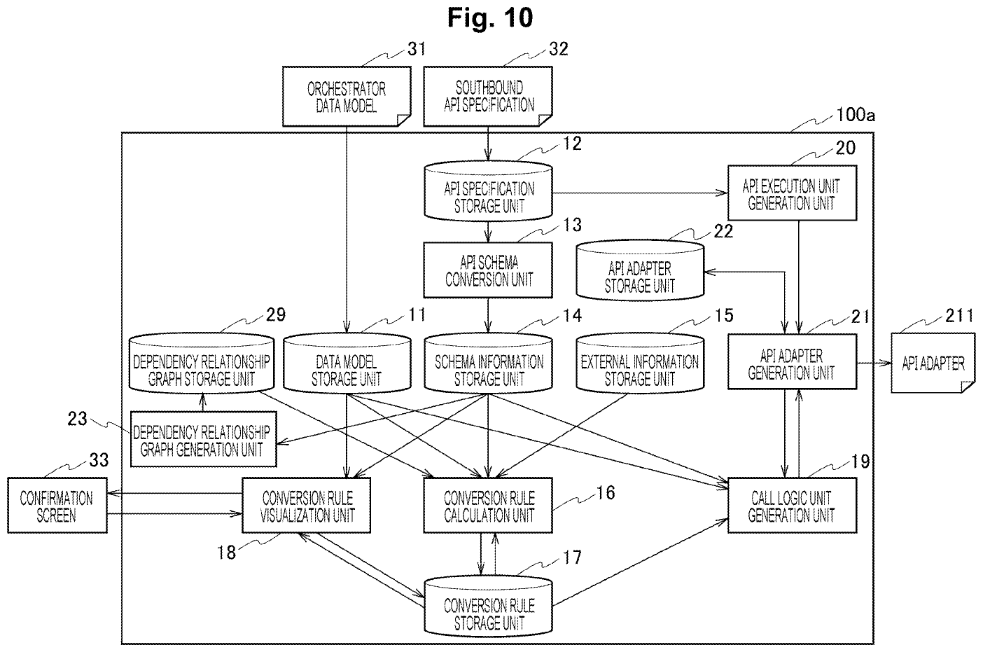

FIG. 10 is a block diagram illustrating a configuration of an API adapter generation device 100a according to the second embodiment. The API adapter generation device 100a illustrated in FIG. 10 is different from the API adapter generation device 100 illustrated in FIG. 3 in that a dependency relationship graph generation unit 23 and a dependency relationship graph storage unit 29 are provided. Hereinafter, the same components as those illustrated in FIG. 3 will be denoted by the same reference numerals, and the description of the configurations will be omitted.

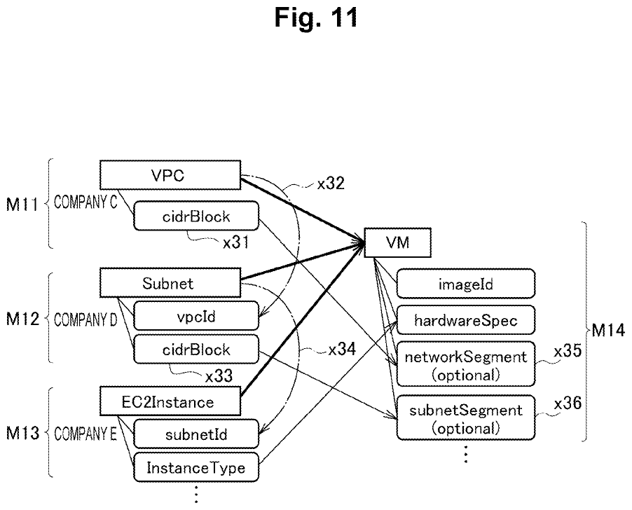

The dependency relationship graph generation unit 23 illustrated in FIG. 10 extracts a dependency relationship between resources in advance from the schema information of the southbound API 212 and generates a graph representation. FIG. 11 is an explanatory diagram illustrating a correspondence relationship when resources and parameters of the data models M11 to M13 of the company C, the company D, and the company E, which are the wholesale service providers 220, are converted into resources and parameters of the data model M14 of the orchestrator.

As indicated by reference numerals x32 and x34 in FIG. 11, the dependency relationship graph generation unit 23 analyzes the dependency relationship between the resources indicated by the reference numerals x32 and x34 from the schema information extracted from the southbound API specification 32 to generate a graph.

The dependency relationship graph storage unit 29 stores the dependency relationship graph generated by the dependency relationship graph generation unit 23.

In addition to the functions of the first embodiment described above, the conversion rule calculation unit 16 aggregates the data models M11 to M13 of the respective companies into one as illustrated in FIG. 11 when a plurality of resources is aggregated into one as preliminary preparation. Specifically, when a plurality of resources is aggregated into one, contribution rates of matching in resource units and parameter units are set in order to improve estimation accuracy and enable many-to-one matching. Furthermore, the contribution rates are made variable.

Specifically, a probability “M (i, j)” that a parameter i matches a parameter j is calculated by the following expression (1).

M(i,j)=k*R(i,j)+(1−k)*P(i,j) (1)

In the expression (1), “M (i, j)” indicates a probability that the parameter i matches the parameter j when the existing schema matching is adopted. “R (i, j)” indicates a matching probability between resources to which the parameters i and j belong. “P (i, j)” indicates a matching probability of only the parameters. “k” is a variable numerical value and indicates a contribution rate of “R (i, j)”.

In the expression (1), weight of the matching in resource units and weight of matching in parameter units are made adjustable. In other words, a numerical value of the contribution rate k is made adjustable.

In addition, the dependency relationship graph generated from the schema information of the southbound API 212 described above is used to enable high-accuracy many-to-one matching.

The conversion rule calculation unit 16 first performs matching while lowering the contribution rate k of the matching information in resource units. In a case where the above matching is achieved, the conversion rule calculation unit 16 confirms the resources to which the parameters belong. In the dependency relationship graph, if they are connected, they all match in a many-to-one correspondence. In a case where there is a plurality of matching possibility resources, one that is connected at a closer distance on the dependency relationship graph is selected.

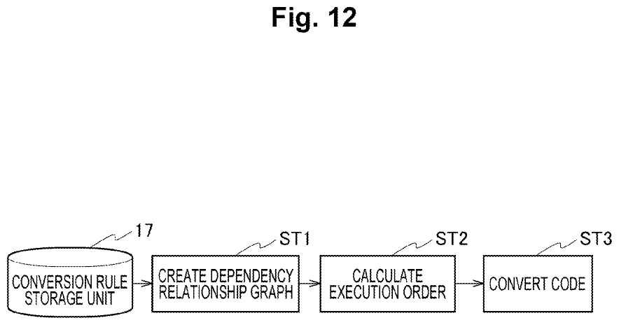

FIG. 12 is an explanatory diagram illustrating procedure of code conversion processing by the API adapter generation device 100a according to the second embodiment. As illustrated in FIG. 12, the model conversion rule stored in the conversion rule storage unit 17 sets the contribution rate “k” of “R(i, j)” illustrated in the above-described expression (1) so that the weight of matching can be adjusted.

In ST1 of FIG. 12, the dependency relationship graph generation unit 23 analyzes the dependency relationship between the plurality of resources on the basis of the schema information extracted from the southbound API specification 32 to generate the dependency relationship graph.

In ST2, the conversion rule calculation unit 16 calculates execution order of the plurality of source codes by using an algorithm such as topological sorting.

In ST3, the call logic unit generation unit 19 rewrites the source code of the API adapter 211 on the basis of the dependency relationship graph and weighting indicated in the expression (1).

As described above, the conversion rule calculation unit 16 calculates a matching scheme by utilizing the variable contribution rate “k” and the dependency relationship graph.

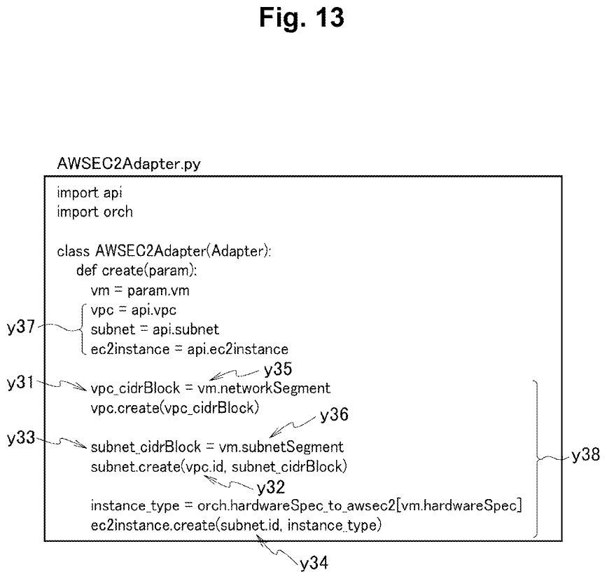

Next, rewriting of the source code will be specifically described with reference to FIGS. 11 and 13. As described above, FIG. 11 is an explanatory diagram illustrating a correspondence relationship when resources and parameters of the data models M11 to M13 of the companies C, D, and E are converted into resources and parameters of the data model M14 of the orchestrator. Furthermore, FIG. 13 is an explanatory diagram illustrating a source code describing the resources and parameters illustrated in FIG. 11.

When the data models M11, 8112, and M13 illustrated in FIG. 11 are converted into the data model M14 of the orchestrator 210, “cidrBlock” indicated by a reference numeral x31 is described in “vpc_cidrBlock” indicated by a reference numeral y31 of the source code illustrated in FIG. 13. Furthermore, a dependency relationship between resources indicated by a reference numeral x12 in FIG. 11 is described in “vcp.id” indicated by a reference numeral y32 in FIG. 13. “cidrBlock” indicated by a reference numeral x33 in FIG. 11 is described in “subnet_cidrBlock” indicated by a reference numeral y33 in FIG. 13.

The dependency relationship between the resources indicated by a reference numeral x34 in FIG. 11 is described in “subnet.id” indicated by a reference numeral y34 in FIG. 13. “networkSegment” indicated by a reference numeral x35 in FIG. 11 is described in “vm.networkSegment” indicated by a reference numeral y35 in FIG. 13. “subnetSegment” indicated by a reference numeral x36 in FIG. 11 is described in “vm.subnetSegment” indicated by a reference numeral y36 in FIG. 13.

A reference numeral y37 illustrated in FIG. 13 indicates definitions of all matching resources. A reference numeral y38 indicates resources generated in the calculated execution order.

As described above, it is possible to perform application to the source code of the API adapter in view of the weighting of each of the data models M1 to M3.

As described above, in the API adapter generation device 100a according to the second embodiment, it is possible to perform matching with high accuracy in a case where a plurality of resources is aggregated into one.

Specifically, the conversion rule calculation unit 16 matches a plurality of resources included in the API specification to be managed to aggregate the plurality of resources into one using the variable contribution rates k and the dependency relationship graph information.

The conversion rule calculation unit 16 performs schema matching on the basis of the data schema of the API specification to be managed after resource aggregation and the data schema of the orchestrator 210 to generate a model conversion rule of the API adapter. As a result, high-accuracy many-to-one matching can be performed, and the new API adapter 211 can be easily generated.

### Description of Third Embodiment

Next, a third embodiment of the present embodiment will be described. If an abstraction level of the data model of the orchestrator 210 increases, deviation between the resource name and the parameter name and the structure thereof increases, which makes matching difficult. While in the existing schema matching method, accuracy is improved by a hybrid method in which instance information is taken into consideration in addition to schema information, in a case where the method is applied to the orchestrator 210, it is difficult to acquire instance information.

In the third embodiment, the matching accuracy is improved by utilizing the instance information and the configuration information included in the orchestrator AP 203 included in the orchestrator 210.

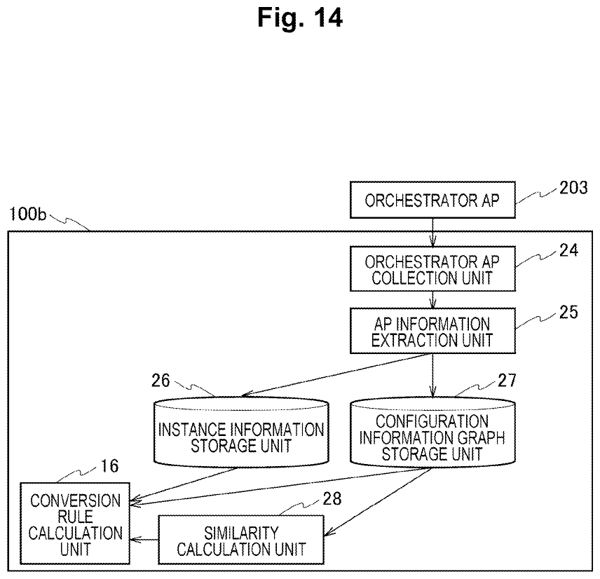

FIG. 14 is a block diagram illustrating a configuration of an API adapter generation device 100b according to the third embodiment. FIG. 14 illustrates only components to be added to the API adapter generation device 100 illustrated in FIG. 3. In other words, the API adapter generation device 100b according to the third embodiment includes components 24 to 28 illustrated in FIG. 14 in addition to the components 11 to 21 illustrated in FIG. 3. Each of the components 24 to 28 will be described below.

An orchestrator AP collection unit 24 illustrated in FIG. 14 collects the orchestrator AP 203 from the orchestrator 210. The orchestrator AP 203 is generated using the northbound API 204. The orchestrator AP 203 is, for example, a catalog.

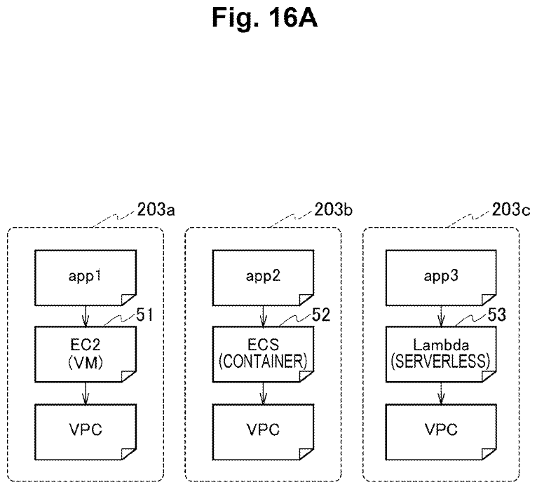

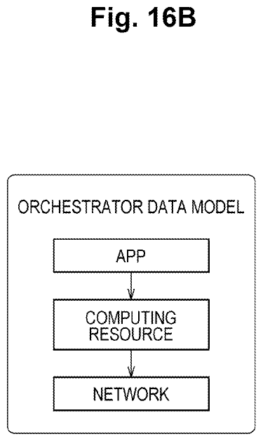

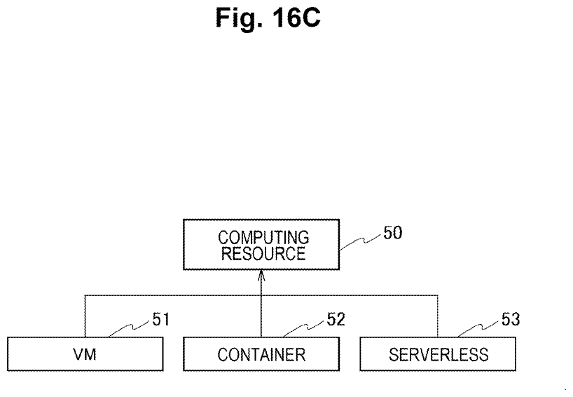

An AP information extraction unit 25 extracts instance information of the southbound API 212 and a configuration information graph of the orchestrator AP from the collected orchestrator AP 203. The “configuration information graph” indicates a data structure of an application, a computing resource, a network, or the like, for example, as illustrated in FIG. 16B to be described later.

An instance information storage unit 26 stores the instance information of the southbound API 212 extracted by the AP information extraction unit 25.

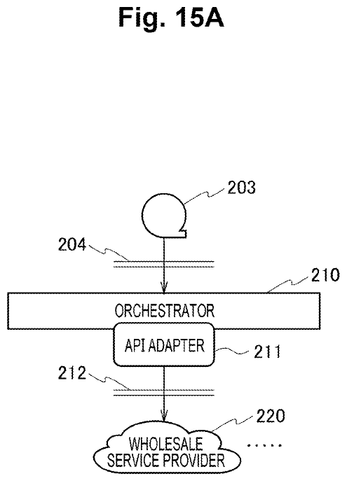

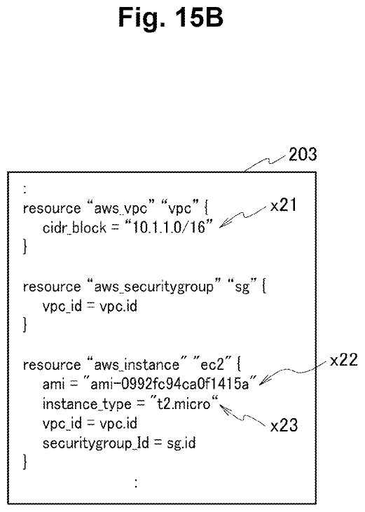

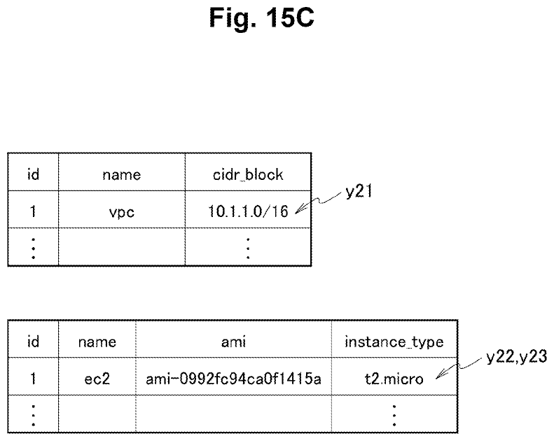

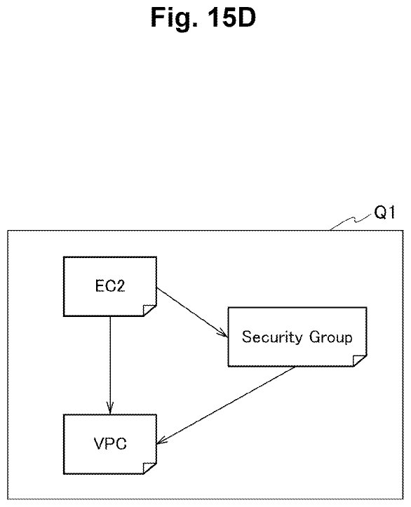

A configuration information graph storage unit 27 stores the orchestrator AP configuration information graph extracted by the AP information extraction unit 25. Specifically, as illustrated in FIG. 15A, the configuration information of the system included in each of the orchestrator APs 203a to 203c is stored as a configuration information graph.

A similarity calculation unit 28 calculates similarity between resources on the basis of the configuration information graph stored in the configuration information graph storage unit 27.

The conversion rule calculation unit 16 calculates a conversion rule of the source code on the basis of the instance information of the southbound API 212, the orchestrator AP configuration information graph, and the similarity between the resources in addition to the orchestrator data model, the schema information, and the external information described above.

FIG. 15A is an explanatory diagram illustrating a relationship between the orchestrator AP 203 and the orchestrator 210. FIG. 15B is an explanatory diagram illustrating a source code describing resources and parameters included in the data model of the orchestrator AP 203 illustrated in FIG. 15A. FIG. 15C is an explanatory diagram illustrating the instance information of the source code illustrated in FIG. 15B. FIG. 15D is an explanatory diagram illustrating the configuration information of the source code illustrated in FIG. 15B.

The conversion rule calculation unit 16 acquires instance information and configuration information indicated by reference numerals x21, x22, and x23 in FIG. 15B and writes data described in each “id” as indicated by reference numerals y21, y22, and y23 in FIG. 15C. Further, as indicated by a reference numeral Q1 in FIG. 15D, the configuration information is set.

In addition, the conversion rule calculation unit 16 sets a higher matching probability for resources that are highly likely to have the same type of concept using similarity of the configuration information graph of the system included in the orchestrator AP 203.

FIG. 16A is an explanatory diagram illustrating configuration information graphs of data models of a plurality of orchestrator APs 203a, 203b, and 203c. FIG. 16B is an explanatory diagram illustrating a configuration information graph of a basic data model of the orchestrator AP 203. FIG. 16C is an explanatory diagram illustrating generation of a computing resource 50 on the basis of similarity of the parameters 51, 52, 53 included in the respective orchestrator APs 203.

The similarity calculation unit 28 compares the structure of “app”, “computing resource”, and “network” illustrated in FIG. 16B with the configuration information of each of the orchestrator APs 203a, 203b, and 203c illustrated in FIG. 16A to calculate similarity between the resources.

For example, in a case where three types of orchestrator APs 203a, 203b, and 203c have parameters of “VM 51”, “container 52”, and “serverless 53”, respectively, as illustrated in FIG. 16A, the computing resource 50 is set on the basis of similarity of the parameters 51, 52, and 53, respectively, as illustrated in FIG. 16C.

As a specific calculation method, the matching probability between the parameter i and the parameter j is set to “M′(i, j)” and is set by the following expression (2).

M′(i,j)=(1−a)·M(i,j)+a·S(i,j) (2)

In the expression (2), “M(i, j)” indicates a probability that the parameter i matches the parameter j when the existing schema matching is adopted. The “S(i, j)” indicates similarity of the parameters i and j in consideration of similarity between resources in the configuration information graph. “a” indicates a contribution rate of the similarity of the configuration information graph. As a result, in the plurality of orchestrator APs 203, a higher matching probability can be set in a case where the resources are highly likely to have the same type of concept.

As described above, in the API adapter generation device 100b according to the third embodiment, by performing schema matching using the above expression (2), a new API adapter 211 can be easily and accurately generated in a case where a plurality of orchestrators AP 203 is provided.

In addition, the API adapter generation device 100b according to the third embodiment calculates the similarity between the resources included in each orchestrator AP 203 on the basis of the configuration information graph included in the information of the orchestrator AP 203. The model conversion rule is generated on the basis of the calculated similarity and the instance information, and the API call logic unit 232 is generated. As a result, it is possible to easily generate the new API adapter 211 with high accuracy.

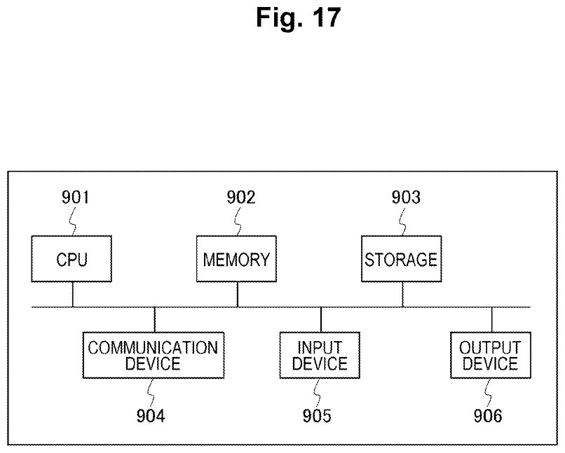

As illustrated in FIG. 17, for example, a general-purpose computer system including a central processing unit (CPU, processor) 901, a memory 902, a storage 903 (hard disk drive (HDD), solid state drive (SSD)), a communication device 904, an input device 905, and an output device 906 can be used as the API adapter generation devices 100, 100a, and 100b of the above-described embodiments. The memory 902 and the storage 903 are storage devices. In this computer system, the functions of the API adapter generation devices 100, 100a, and 100b are implemented by the CPU 901 executing a predetermined program loaded on the memory 902.

Note that the API adapter generation devices 100, 100a, and 100b may be implemented by one computer or may be implemented by a plurality of computers. The API adapter generation devices 100, 100a, and 100b may be virtual machine mounted on a computer.

Note that a program for the API adapter generation device 100, 100a, and 100b can be stored in a computer-readable recording medium such as an HDD, an SSD, a universal serial bus (USB) memory, a compact disc (CD), or a digital versatile disc (DVD), or can be distributed via a network.

Note that the present invention is not limited to the above embodiments, and various modifications can be made within the scope of the gist of the present invention.

### REFERENCE SIGNS LIST

11 data model storage unit
12 API specification storage unit
13 API schema conversion unit
14 schema information storage unit
15 external information storage unit
16 conversion rule calculation unit
17 conversion rule storage unit
18 conversion rule visualization unit
19 call logic unit generation unit (generation unit)
20 API execution unit generation unit
21 API adapter generation unit
22 API adapter storage unit
23 dependency relationship graph generation unit
24 orchestrator AP collection unit
25 AP information extraction unit
26 instance information storage unit
27 configuration information graph storage unit
28 similarity calculation unit
29 dependency relationship graph storage unit
31 orchestrator data model
32 southbound API specification
33 confirmation screen
100, 100a, 100b API adapter generation device
200 network system
201 end user
202 service provider
203 orchestrator AP
210 orchestrator
211 (211a to 211d) API adapter
220 (220a to 220d) wholesale service provider
231 order reception unit
232 API call logic unit
233 southbound API execution unit

1. An application programming interface (API) adapter generation device comprising:
a conversion rule calculation unit, implemented using one or more computing devices, configured to:
acquire a data model of an orchestrator and an API specification to be managed, and
perform schema matching based on a data schema of the orchestrator and a data schema of the API specification to calculate a model conversion rule;
a generation unit, implemented using one or more computing devices, configured to rewrite a source code of an API call logic unit describing an API adapter execution logic based on the model conversion rule; and
an API adapter generation unit, implemented using one or more computing devices, configured to generate an API adapter to be managed based on the API call logic unit in which the source code is rewritten.

2. The API adapter generation device according to claim 1, wherein the conversion rule calculation unit is configured to calculate the model conversion rule by performing schema matching on the data model of the orchestrator and the API specification to be managed in units of at least one of resources or parameters.

3. The API adapter generation device according to claim 1,
wherein the conversion rule calculation unit is configured to:
aggregate a plurality of resources included in the API specification to be managed into one resource by performing matching using a variable contribution rate and dependency relationship graph information, and
perform schema matching based on (i) the data schema of the API specification to be managed after the resources are aggregated and (ii) the data schema of the orchestrator.

4. The API adapter generation device according to claim 1, wherein the generation unit is configured to generate the API call logic unit by setting a template of a predetermined source code and rewriting the predetermined source code by writing at least one of resources, parameter names, or parameter values of the API specification to be managed in the template.

5. The API adapter generation device according to claim 1, further comprising:
an information extraction unit, implemented using one or more computing devices, configured to extract instance information and a configuration information graph from information of an orchestrator AP included in the orchestrator; and
a similarity calculation unit, implemented using one or more computing devices, configured to calculate a value indicating similarities between respective resources included in the orchestrator AP based on the configuration information graph,
wherein the conversion rule calculation unit is configured to generate the model conversion rule based on the instance information and the value indicating similarities.

6. The API adapter generation device according to claim 1, wherein the schema matching uses at least one of a graph based method, an instance based method, or a hybrid method that combines the instance based method and schema information.

7. An application programming interface (API) adapter generation method to be performed by a computer, the API adapter generation method comprising:
acquiring a data model of an orchestrator and an API specification to be managed;
performing schema matching based on a data schema of the orchestrator and a data schema of the API specification to calculate a model conversion rule;
rewriting a source code of an API call logic unit describing an API adapter execution logic based on the model conversion rule; and
generating an API adapter to be managed based on the API call logic unit in which the source code is rewritten.

8. A non-transitory computer-readable medium storing an application programming interface (API) adapter generation program, wherein execution of the API adapter generation program causes one or more computers to perform operations comprising:
acquiring a data model of an orchestrator and an API specification to be managed;
performing schema matching based on a data schema of the orchestrator and a data schema of the API specification to calculate a model conversion rule;
rewriting a source code of an API call logic unit describing an API adapter execution logic based on the model conversion rule; and
generating an API adapter to be managed based on the API call logic unit in which the source code is rewritten.
